(19) United States
(12) Patent Application Publication
(10) Pub. No.: US 2023/0286109 A1
(43) Pub. Date: Sep. 14, 2023

(54) AN IMPROVED BLAST NOZZLE

(71) Applicant: BLASTONE TECHNOLOGY PTY LTD, Red Hill, Queensland (AU)

(72) Inventors: Matthew ROWLAND, Canterbury (AU); Joshua KEEP, Currumbin Valley (AU); Ingo JAHN, Upper Brookfield (AU)

(21) Appl. No.: 18/018,557

(22) PCT Filed: Jul. 29, 2021
(86) PCT No.: PCT/AU2021/050827

§ 371 Date: Jan. 28, 2023

Related U.S. Application Data
(60) Provisional application No. 63/059,364, filed on Jul. 31, 2020.

(30) Foreign Application Priority Data
Jul. 29, 2020 (AU) 2020902661

(51) Int. Cl. B24C 5/04; B05B 7/14; B05B 15/18

(52) U.S. Cl. CPC B24C 5/04; B05B 7/1486; B05B 15/18

(57) ABSTRACT

a blast nozzle is provided that has a conduit through it for accelerating air applied to the blast nozzle at pressure greater than ambient pressure. The air contains abrasive particles for abrading or “blasting” a workpiece. The conduit includes an inlet portion that converges from an inlet opening for receiving the air, to a throat for accelerating the air to a sonic speed. The conduit also includes an outlet portion that extends from the throat to a nozzle outlet for accelerating the air from the throat to a super-sonic speed at the nozzle outlet. A ratio of area of the nozzle outlet to area of the throat is selected for expansion of the air through the conduit so that air is emitted from the nozzle outlet in a jet at an ambient pressure. The jet imparts drag on the abrasive particles between the nozzle outlet and the workpiece which has been found to improve abrading of the workpiece by the abrasive particles.

### RELATED APPLICATIONS

Priority is claimed from Australian provisional patent application No. 2020902661 filed 29 Jul. 2020 and from U.S. provisional patent application No. 63/059,364 filed 31 Jul. 2021, the contents of which are each hereby incorporated by reference.

### FIELD

The present disclosure relates to a nozzle for a pneumatic blasting system. Such systems utilise jets of high velocity air or other gases containing abrasive material for blasting a surface of a workpiece in order to clean and/or abrade the surface.

### BACKGROUND

Any references to methods, apparatus or documents of the prior art or related art are not to be taken as constituting any evidence or admission that they formed; or form, part of the common general knowledge.

It is known to provide a blasting apparatus in which particles of abrasive material entrained in a stream of pressurised gas, most usually air, are expelled from a nozzle in a high velocity jet of the air that is directed onto a surface in order that the particles forcibly impact the surface to clean and/or abrade the surface.

One historically used abrasive material is sand, and when sand is used the blasting process may be referred to as sand blasting. However, other abrasive materials may be used, and garnet is often preferred to silica sand.

A nozzle comprises a body of hardwearing material through which a conduit for the stream of pressurised gas is formed. Commonly, the conduit is shaped so that the nozzles are comprised of a converging inlet portion, which includes an inlet opening for coupling to a source of the pressurised gas such as a blast pot. The inlet portion converges to a throat from which an outlet portion of the conduit extends to a nozzle outlet. The convergence of the inlet portion to the throat raises the velocity of the pressurised gas to approximately sonic speeds. The outlet portion may be formed to diverge from the throat to the nozzle outlet in order to further increase the velocity of the air so that the jet that is emitted from the nozzle outlet is at a high velocity.

Optimising the shape of the nozzle conduit to best transfer kinetic energy from the pressurised air to the particles of abrasive material has been the subject of much experimentation for decades. The advantages of such optimisation include greater efficiency, reduced consumption of abrasive material and shorter worker hours required for a given blasting task.

### SUMMARY

According to a first aspect of the present disclosure there is provided a blast nozzle having a conduit therethrough for accelerating air applied to the blast nozzle at pressure greater than ambient pressure, the air containing abrasive particles for abrading a workpiece, the conduit including:
an inlet portion converging from an inlet opening for receiving the air, to a throat for accelerating the air to a sonic speed;
an outlet portion extending from the throat to a nozzle outlet for accelerating the air from the throat to a super-sonic speed at the nozzle outlet; and
wherein a ratio of area of the nozzle outlet to area of the throat is selected for expansion of the air through the conduit so that air is emitted from the nozzle outlet in a jet at an ambient pressure wherein the jet imparts drag on the abrasive particles between the nozzle outlet and the workpiece for improving abrading of the workplace by the abrasive particles.

In an embodiment the inlet portion converges from the inlet opening for receiving the air at 80-120 psi to the throat for accelerating the air to the sonic speed at the throat.

In an embodiment the ratio of the area of the nozzle outlet to the area of the throat is 1.66+/−0.05 to emit the air, received into the inlet opening at 80-120 psi, from the nozzle outlet in the jet wherein the jet imparts drag on the abrasive particles between the nozzle outlet and the workplace for abrading of the workplace by the abrasive particles.

In an embodiment the ratio of the area of the nozzle outlet to the area of the throat is 1.64.

In an embodiment in use a ratio of pressure of the air at the throat to pressure of air at the nozzle outlet is between 6 and 9.5 for emitting the air from the nozzle outlet in the jet wherein the jet imparts drag on the abrasive particles between the nozzle outlet and the workpiece for abrading of the workpiece by the abrasive particles.

In an embodiment the ratio of pressure of the air at the throat to pressure of air at the nozzle outlet is between 6.5 and 9.0.

In an embodiment the ratio of pressure of the air at the throat to pressure of air at the nozzle outlet is between 6.4 and 9.2.

In an embodiment the ratio of pressure of the air at the throat to pressure of air at the nozzle cutlet is 7.8.

In an embodiment the inlet portion comprises a concave-convex curve for minimising wear of the inlet portion.

In an embodiment the throat has a length that is zero or less than 5% of a length of the outlet portion.

In an embodiment the outlet portion includes a first diverging sub-portion following the throat.

In an embodiment the outlet portion includes a second diverging sub-portion following the first diverging sub-portion.

In an embodiment the first diverging sub-portion diverges more than the second diverging sub-portion per unit of axial length along the conduit.

In an embodiment the first diverging sub-portion comprises a bell shape.

In an embodiment the second diverging sub-portion comprises linearly tapering shape to the nozzle outlet.

In an embodiment the outlet portion is formed to diverge linearly from the throat to the nozzle outlet.

In an embodiment the blast nozzle is arranged to operate the air entering the inlet portion to be at a pressure of 100 psi at 27 degrees C. with the ambient pressure being 14.7 psi at 27 degrees C.

In an embodiment the nozzle outlet has a diameter of between 6 mm and 17 mm and the throat has a diameter of between 4 mm and 13 mm.

In an embodiment the throat and the nozzle outlet are separated by a distance of less than 300 mm.

In an embodiment the throat and the nozzle outlet are separated by a distance of between 110 mm and 295 mm.

In an embodiment the inlet opening has a diameter of 32 mm.

In an embodiment the throat has a diameter of 9.5 mm and the nozzle outlet has a diameter of 12 mm.

In an embodiment the throat and the nozzle outlet are separated by a distance of 220 mm.

In an embodiment the inlet and the throat are separated by a distance of 36 mm.

According to another aspect of the present disclosure there is provided a method of making a blast nozzle having a conduit therethrough for accelerating air, the conduit having an inlet portion converging from an inlet opening for receiving pressurised air to a throat and an outlet portion diverging from the throat to a nozzle outlet, the method comprising:
forming a parametric curve for defining a surface of the outlet portion;
estimating entropy rise of a fluid flow through the outlet portion for a number of different shapes of the parametric curve;
finalising the parametric curve as a finalised parametric curved determined as a one of the number of different shapes ascertained to minimise the entropy rise of the fluid flow along the outlet portion; and
producing the blast nozzle with the outlet portion having a curve based upon the finalised parametric curve.

In an embodiment estimating the entropy rise of the fluid flow is performed for fluid comprising pressurised air applied to the inlet opening in a pressure range of 80 psi to 120 psi.

In an embodiment estimating the entropy rise of the fluid flow is performed for fluid comprising pressurised air applied to the inlet opening at 100 psi.

In an embodiment the parametric curve is defined by a plurality of control points.

In an embodiment the different shapes of the parametric curve are attained by varying a number of the plurality of control points.

In an embodiment the plurality of control points includes a fixed control point at the throat.

In an embodiment producing the blast nozzle includes forming the outlet portion corresponding to the finalised parametric curve.

In an embodiment producing the blast nozzle includes forming the outlet portion as an approximation of the finalised parametric curve wherein an area of the nozzle outlet corresponds to a nozzle outlet area according to the finalised parametric curve and an area of the throat corresponds to a throat area according to the finalised parametric curve.

In an embodiment the approximation of the finalised parametric curve comprises a straight line from the throat to the nozzle outlet.

In an embodiment a ratio of area of the nozzle outlet to area of the throat results in pressurised air entering the inlet being emitted from the nozzle outlet in a jet at ambient pressure wherein the jet imparts drag on abrasive particles entrained in the air, between the nozzle outlet and a workpiece to thereby improve abrading of the workpiece by the abrasive particles.

In an embodiment producing the blast nozzle includes making the blast nozzle with a throat of zero length.

In an embodiment producing the blast nozzle includes making the inlet portion with a curve shaped to minimise rise in entropy from the inlet to the throat.

In an embodiment producing the blast nozzle includes making the inlet portion with a concave-convex curve from the inlet to the throat.

According to a further aspect of the present disclosure there is provided a blasting system comprising a blast pot in combination with the blast nozzle wherein a pressurised air outlet of the blast pot is coupled to the inlet of the blast nozzle and wherein the blast pot is configured to produce the air pressurised at 80 psi to 120 psi with the abrasive particles entrained therein.

According to another aspect of the present disclosure there is provided a blast nozzle made in accordance with the method.

According to a further aspect of the present disclosure there is provided blast nozzle for accelerating air containing abrading particles for abrading a workpiece.

It should be appreciated that features or characteristics of any aspect or embodiment thereof, as set forth in the preceding Summary or as described in the following detailed description, may be incorporated into any other aspect unless logic dictates otherwise.

### BRIEF DESCRIPTION OF THE DRAWINGS

Embodiments in accordance with the present disclosure will be described, by way of example, in the following Detailed Description of Embodiments which provides sufficient information for those skilled in the art to perform the invention. The Detailed Description of Embodiments is not to be regarded as limiting the scope of the preceding Summary section in any way. The Detailed Description will make reference to the accompanying drawings, by way of example, in which:

FIG. 1 depicts a prior art blast nozzle in use.

FIG. 2 is a parametric diagram showing the geometry of a wall of a conduit through a prior art blast nozzle.

FIG. 3 is a diagram showing the general shape of the preferred embodiment compared to a manufactured version thereof.

FIG. 4 is a diagram showing the general shape of a less preferred embodiment.

FIG. 5 is a view of blast nozzle according to a preferred embodiment.

FIG. 6 is a view of a nozzle outlet end of the blast nozzle of FIG. 5.

FIG. 7 is a side view of the nozzle of FIG. 5.

FIG. 8 is a longitudinal cross section of the nozzle of FIG. 5.

FIGS. 9 and 10 are tables presenting dimensions and ratios of a number of nozzles according to embodiments herein including the nozzle of FIGS. 5 to 8.

### DETAILED DESCRIPTION OF EMBODIMENTS

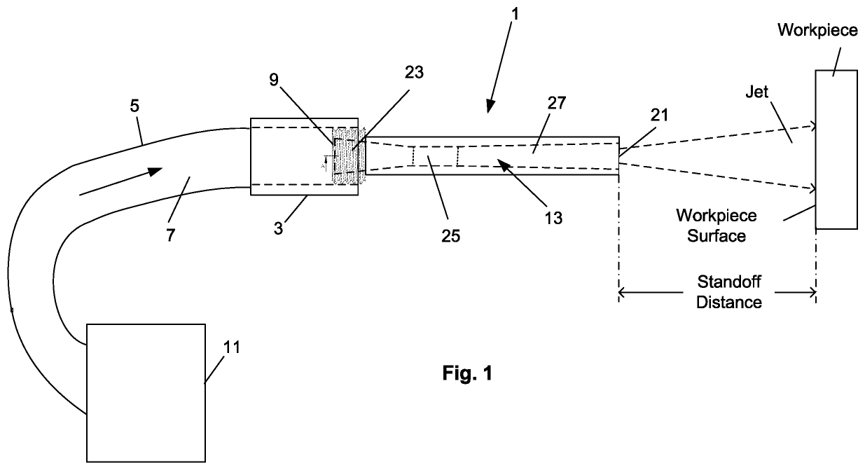

FIG. 1 depicts a blasting nozzle 1 in use. The blasting nozzle 1 is coupled by a connector 3 to a hose 5 through which high pressure air 7 containing abrasive particles is passed to an inlet 9 of the nozzle 1 from a blast pot 11. The nozzle 1 is formed with an internal, longitudinal conduit 13 which is shaped to accelerate the air 7 so that the air is emitted from the nozzle outlet 21 in a high velocity jet 15 that is directed against a surface 17, spaced a distance L from nozzle outlet 19. Surface 17 is a surface of a workpiece 19 that is cleaned and abraded by the abrasive particles in the jet 15. The conduit 13 of the blasting nozzle 1 that is shown in FIG. 1 is formed with a converging inlet portion 23 that extends from the nozzle inlet 9 to an axially extending throat 25, which is of constant diameter. A diverging outlet portion 27 extends from the throat 25 to the nozzle outlet 21.

Blast nozzles are typically sized by their throat diameter in fractions of an inch, e.g. a #6 blast nozzle has a throat diameter of 6/16″ whereas a #3 blast nozzle has a throat diameter of 3/16″.

Initially two #6 prior art nozzles were investigated both numerically and experimentally. Both of the prior art nozzles are characterised by inlet (converging) and outlet (diverging) conical sections connected by a cylindrical throat section having an axially extending throat of constant diameter.

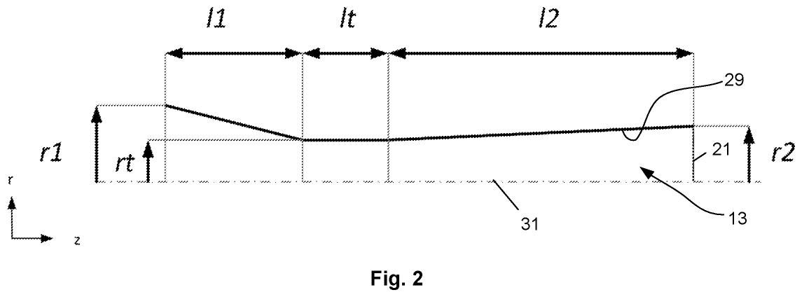

A geometry for a conduit of such a nozzle is parametrically illustrated in FIG. 2, with dimensions given in table 1 for two particular nozzles, Nozzle 1 and Nozzle 2. It will be realised that the profile of the conduit wall that is shown corresponds to the three dimensional conduit once the profile is rotated about the axis that is indicated in the figure to form a volume of revolution thereabout. In FIG. 2 the conduit is indicated as item 13, the profile of the conduit wall is indicated as item 29 and the longitudinal axis of the conduit through the nozzle is indicated as item 31.

TABLE 1
Blast nozzle geometric characteristics,
see FIG. 2 for parameter locations.

| Nozzle | l1 | l2 | lt | r1 | r2 | rt |
|---|---|---|---|---|---|---|
| 1 | 70 | 220 | 15 | 16 | 7 | 4.765 |
| 2 | 44 | 108 | 17 | 15.7 | 6.75 | 4.765 |

Nominal flow conditions for this investigation were specified as 80 to 120 psi nozzle inlet conditions discharging to ambient temperature and pressure 14.5 psi, 27 degrees C.).

A numerical investigation was completed using a two-way coupled two-phase air-particle computational fluid dynamics (CFD) model, whilst the experimental investigation utilised results from particle tracking of images captured using high speed shadowgraphy. A key observation from CFD was that particles accelerated downstream of the nozzle outlet.

Prior art approaches to nozzle design, e.g. that of U.S. Pat. No. 5,975,996 have focused on maximizing particle velocity at the nozzle outlet without considering the downstream flow field or its impact on particle velocity prior to impact on the workpiece surface.

Nozzles that aim to accelerate within the nozzle may incur significant losses in the gas stream, thus inhibiting the ability to impart further energy upon abrasive particles between the nozzle exit and the workpiece.

It has now been hypothesised that it may be possible to add energy to the particles between the outlet from the nozzle and the surface of the workpiece by improving the efficiency of gas expansion within the nozzle.

These observations have led to a realisation that the blast nozzle design paradigm has needed to shift from one having the objective of maximizing abrasive particle velocity at the nozzle outlet to one which results in maximising abrasive particle energy at the work piece.

To that end a new baseline nozzle geometry has been conceived, incorporating features with intrinsically lower losses. Embodiments of the nozzles include one or more of the following features and preferred embodiments include all of the features as follows:
A throat with zero (i.e. “knife edge”) or small axial length, instead of the customary elongated cylindrical throat section. For example, the prior art nozzles of Table 1 have cylindrical throat sections with axial lengths (lt) that are about 6% and 16% of the axial length (l2) of their respective outlet portions. In contrast the throat of embodiments herein are preferably less than 5% of the axial length of the outlet portion and most preferably zero, i.e. a knife edge throat.
An inlet of general concave-convex outline instead of the customary conical section.
An isentropic area ratio close to that for ideal expansion with a nominal operating pressure ratio in the range of 6.0 to 9.5 and more preferably of 7.8
An outlet portion extending from the throat to a nozzle outlet wherein a ratio of the nozzle outlet area to the throat area is 1.66+/−0.05. With the above general characteristics, the inventor utilised automated shape optimisation in conjunction with air only CFD to produce two candidate designs for validation. Air only CFD was utilised, to enable faster computation. The optimisation and validation process was conducted on a #6 sized nozzle. For shape optimisation, two objective functions were considered as follows:

1. Entropy

Total losses in a fluid stream, i.e. the air streaming through the nozzle, are proportional to entropy rise over the region of interest. For blast nozzles, the inventor hypothesized that both frictional and shock losses are key, and are accounted for by entropy rise. As inlet flow conditions are fixed, entropy rise is accounted for by the flux and time averaged value of entropy at the nozzle outlet of a given nozzle geometry.

2. Dynamic Pressure

Particle energy transfer is related to particle drag, as shown in Equation 1.

$${F}_{D} = \frac{1}{2} {C}_{D} ρΔ {V}^{2} \qquad ( 1 )$$

Where C_{D} is the particle drag coefficient, proportional to local fluid conditions, ρ is the fluid density, and ΔV is the difference between particle and fluid velocity.

For an approximately constant drag coefficient, and low particle velocity, potential energy transfer to particles is proportional to ρVₐₓ², where Vₐₓ is the component of fluid velocity parallel to the axis of the nozzle.

The sum of time averaged values obtained along the centreline at discrete locations were used as an objective function, which is a measure of the average Centreline samples were compared with flux averaged values of discrete slices for a test case, which showed that centreline values appropriately accounted inviscid core flow.

In utilising as an objective function, only the supersonic section, i.e. the outlet portion, of the nozzle was considered owing to the much greater fluid velocity, and hence much greater potential for energy transfer.

### Geometry Parameterisation

### Inlet

The outer surface of the inlet was parameterised using a smooth, continuous curve, appropriately constrained to yield a concave-convex curved inlet. The start of the inlet curve is of fixed diameter, and of variable length. The end of the inlet curve is fixed at the nozzle throat. For example, FIG. 16 illustrates an embodiment of a nozzle 100 with an inlet 106 of a concave-convex curved inlet conduit portion 104. The inlet portion 104 has an initial concave portion 110 that changes at inflexion 112 to a convex portion 114 that leads to throat 116 of diameter D.

### Outlet—Simple Parameterisation

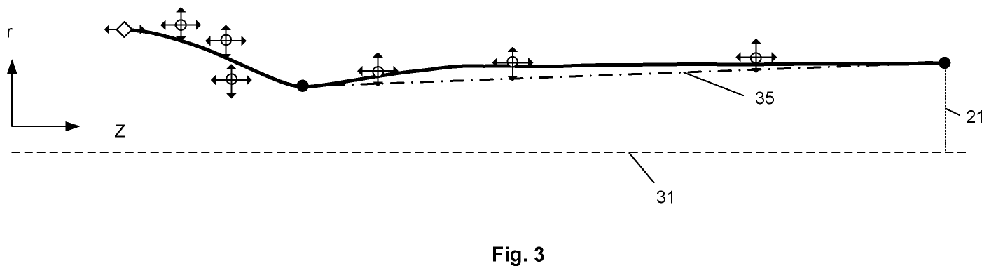

As a possible enhancement to the straight taper diverging outlet sections used in current product, a smooth, continuous curve was used to parameterise a general nozzle outlet portion and shown in FIG. 3. FIG. 3 is a schematic diagram of a nozzle inlet parameterisation with a simple outlet parameterisation that is sometimes referred to herein as “Geometry 1”. The length of the diverging sections was constrained to 125 mm, in line with a prior art nozzle. The profile of the conduit wall manufactured with the outlet portion as a straight line is indicated by dashed line 35.

### Outlet—Split Parameterisation

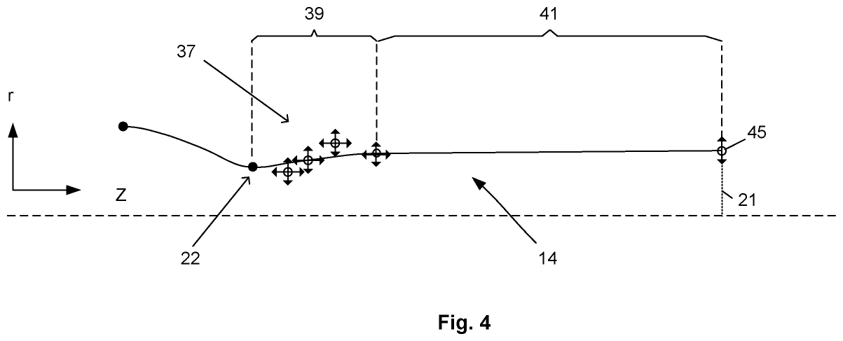

Inspection of Equation 1 reveals that in order to accelerate particles over a minimum axial length, it is desirable to accelerate the flow as soon as possible in the diverging section of the nozzle. To achieve this, a split parameterisation may be used; composed for example as shown in FIG. 4, an outlet first sub-portion 39 comprising a bell shaped nozzle (corresponding to the minimum length nozzle for accelerating the flow to the design Mach number), and a second linearly tapering frusto-conical shaped sub-portion 41 downstream (to maintain design Mach number until the exit 21 of the nozzle whilst accounting for boundary layer growth).

The outer surface of the first outlet sub-portion 39 of the conduit 14 was initially parameterised utilising a smooth, continuous curve with the start of the first outlet sub-portion curve 39 fixed at the nozzle throat 22, with the end of the first outlet curve first approximated using a Method-of-Characteristics (MoC) design approach. The outer surface of the second outlet sub-portion 41 was specified as linear, with the outlet free to move radially. The parameterisation was further enhanced to enable the length and radius of the acceleration section, i.e. the first, bell-shaped sub portion, of the nozzle outlet portion to change in order to account for viscous effects. FIG. 4 shows parameterisation control points 37 for the first outlet sub-portion 39 of the conduit 14 to account for viscous effects. Outlet 21 was free to increase or decrease radially as indicated by control point 43.

The overall length of the diverging outlet sub-portions 39, 41 was constrained to 125 mm, consistent with the first outlet parameterisation and a current product nozzle.

### Optimisation Process

To optimise the nozzle, the geometry was functionally separated into inlet and outlet sections to reduce degrees of freedom (complexity) in shape optimisation. Given the lower velocities of the inlet (and hence low potential for energy transfer to particles), entropy minimisation was indicated to be the preferred objective function of those considered. One of the benefits of entropy minimisation is that it also generates a uniform flow field for downstream sections, i.e. velocity gradients in the outflow will be more uniform, leading to more uniform energy transfer to particles. The inlet was optimised first for entropy minimisation, in conjunction with a preliminary outlet geometry. The selected inlet from this process was then used for all other outlet design optimisations, for which several combinations of the aforementioned objective functions and geometry parameterisations are considered.

### Inlet Optimisation

The entropy minimisation objective function was utilised. The selected inlet geometry was utilised for all other presented outlet optimisations that are discussed.

### Outlet Optimisation—Minimisation of Entropy Rise

The selected inlet described above was used in conjunction with the simple outlet parameterisation. The selected geometry from this optimisation process was further selected for experimental validation as Geometry 1 (FIG. 3).

### Outlet Optimisation—Maximisation of Dynamic Pressure

The selected inlet described above was used in conjunction with the outlet parameterisations described in relation to FIG. 4. The previously mentioned dynamic pressure objective function was utilised. The selected geometry from this optimisation process was further selected for experimental validation as Geometry 2 (FIG. 4).

For cross verification of the optimisation process, the objective functions and parameterisations used to generate the above selected geometries were swapped and additional optimisations were conducted. Designs output from this process showed lower performance for their respective objective functions than those already selected, thus suggesting that the appropriate parameterisations were selected for the original objective functions.

### Prototype Manufacture of Selected of Geometries

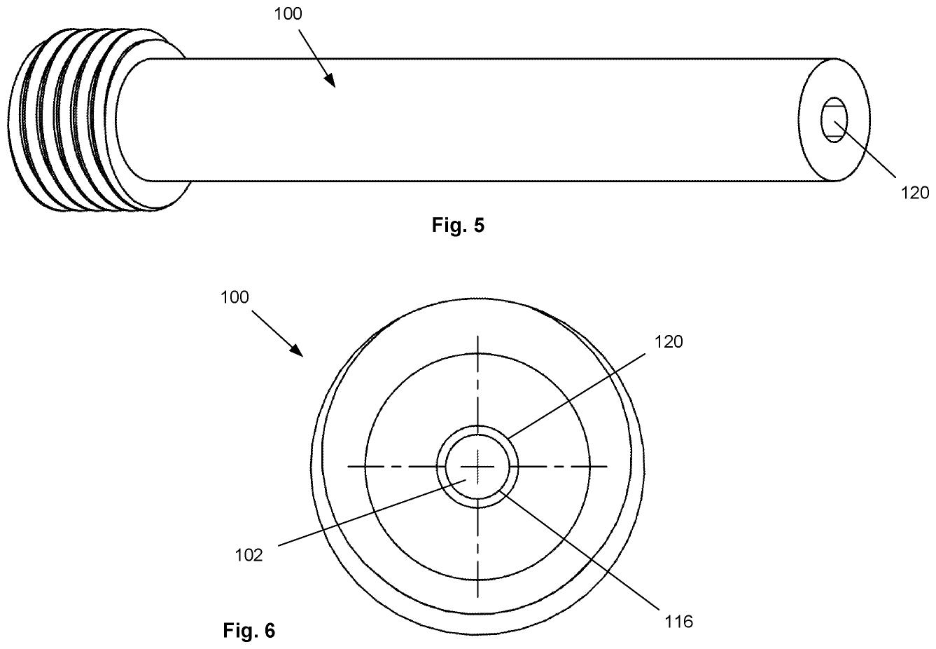

Based on the above optimisation studies, two geometries were selected for testing experimentally. Prototype nozzles were manufactured, however the prototype nozzles were not to design intent. Differences are summarised below.
Geometry 1 (FIG. 3)—diverging section was manufactured as a straight taper, as shown in dashed line in FIG. 3, the smooth curve definition was not followed. However, the outlet to throat area ratio was as per design intent.
Geometry 2 (FIG. 4)—linear diverging section (second outlet sub-portion was manufactured as cylindrical (constant diameter corresponding to end of rapid diverging section as shown in dashed line in FIG. 6). Overall the outlet to throat area ratio was less than design intent. Subsequently a design intent version of Geometry 2 was obtained and was found to perform consistent with modelled results for the original.

To assess the impact of these features on nozzle performance, the manufactured prototype geometry was simulated and compared to the original design intent. Results show that the performance of as-manufactured units are all distinct from each other; i.e. the performance difference between design intent and as manufactured was less than the difference between respective designs.

### Comparison of Results to Blast Cabinet

Nozzle designs (as-manufactured) were separately validated in an automated blast cabinet to test for coating removal rate. A key result of this test was a comparative removal rate, which showed that Geometry 1 outperformed the baseline, particularly at lower pressures, whilst Geometry 2 performed worse than the baseline for all pressures.

Considering particle velocity estimates at the nozzle outlet (obtained from particle CFD) were lower for Geometry 1 than the baseline, assuming velocity is related to cleaning rate, the high performance of Geometry 1 in the cabinet test can only be explained by significant particle acceleration downstream of the nozzle.

Considering the poor performance of Geometry 2, it was hypothesised that field oscillations in the minimum length nozzle and strong shocks external to the nozzle (seen in particle CFD) lead to a more rapid breakdown of the high dynamic pressure jet exiting the nozzle when compared to other geometries. The Inventor hypothesised that the dynamic pressure characteristics of Geometry 1 were better maintained downstream than for the other geometries tested due to operation at the design pressure ratio, and due to smooth supersonic expansion.

### Comparison of Results to Optical Experiment

Optical shadowgraphy was used to determine particle velocity as a function of geometry and nozzle operating conditions. The same abrasive control valve setting was used for all tests. Particle velocity was determined using particle tracking over the entire image area.

Particle velocity as a function of downstream distance and nozzle operating pressure was obtained. The following observations were made from the shadowgraphy:
Geometry 2 was observed to be a much less preferred performer, which was consistent with the cabinet experiment.
Geometry 1 was observed to show very consistent performance (15 m/s variation) with downstream distance and pressure, i.e. it showed greater design robustness.
Trends in particle energy determined from velocity at the furthest downstream measurement location are proportional to coating removal rate determined in the cabinet experiment, i.e. coating removal rate is proportional to particle energy.
In contrast, prior art nozzles were observed to display higher nozzle outlet velocities that dropped off after 150 mm downstream more significantly than geometry 1.
Observations in respect of prior art nozzles, indicate that increasing nozzle length increases particle velocity at the nozzle outlet, however particle velocity reduces more rapidly downstream subsequent to the nozzle outlet. Prior art nozzles, which are longer, are believed to be susceptible to this effect.

The Inventor has realised that maintaining a jet comprising a high energy gas field downstream of the nozzle outlet is important for improving particle velocity at the work piece.

Considering the above, entropy minimisation was found to be a suitable objective function for the design of nozzles, subject to the constraint of designing to the appropriate area ratio for the operating pressure.

The simulations used to design the nozzles with entropy minimisation objective function) used gas only (i.e. no particles) and arrived at the same result as the analytical solution (as set forth for example in “Design of Liquid Propellant Rocket Engines” Huzel & Huang, NASA 1967 (Chapter 1)). for ideal area ratio, with slight modification to account for boundary layer displacement thickness. The preferred area ratio is a few percent larger than isentropic due to this.

Consequently, nozzles according to embodiments of the invention have an outlet to throat area ratio of 1.66+/−0.35 to deliver ideal expansion ratio at the selected design pressure with consideration for viscous flow.

Optical and blast cabinet results indicate good correlation between downstream abrasive kinetic energy determined from the optical experiment and coating removal rate determined from the cabinet experiment for the geometries and operating points tested.

Manufacturing nozzles with straight tapered diverging sections shows minimal impact on performance compared to design intent. This technique is suitable for further prototype manufacture, however additional improvements are possible with surface contouring for production designs.

Given that particles still accelerate beyond the nozzle, optimal nozzle length is a trade-off between losses in the nozzle and external jet breakdown.

Observing the improved performance of Geometry 1, it was recognised that diverging section length was the remaining variable in tuning the design, and this could not be appropriately evaluated with CFD. Three additional geometries were trialled with diverging lengths from −90-220 mm, No automated optimisation was done, as inlet designs and area ratio were maintained. Furthermore, a conical diverging section was used in each.

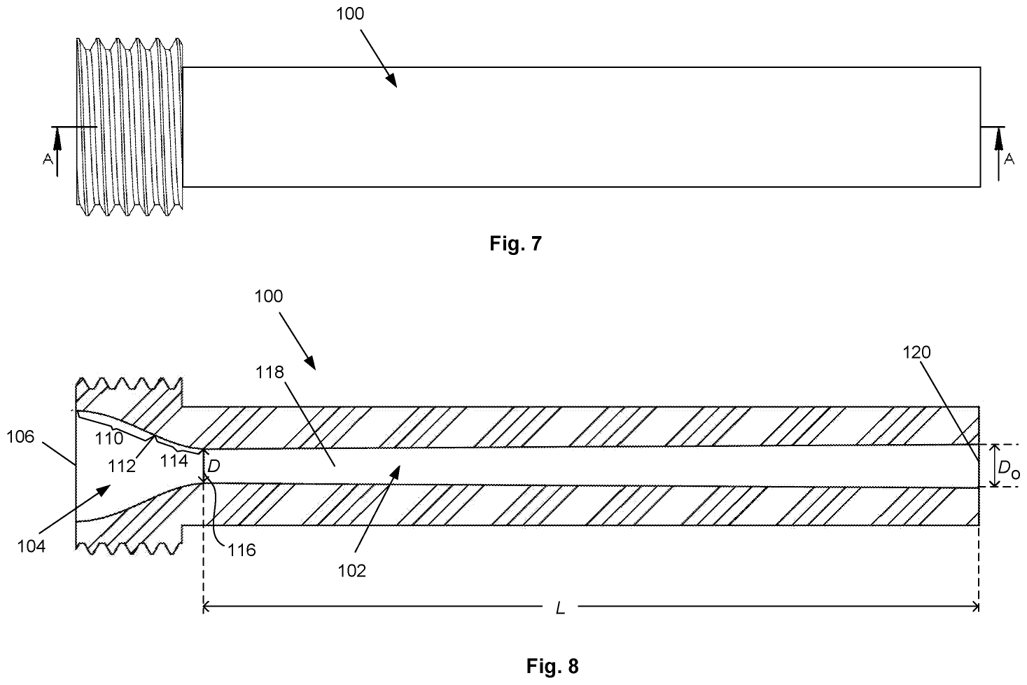

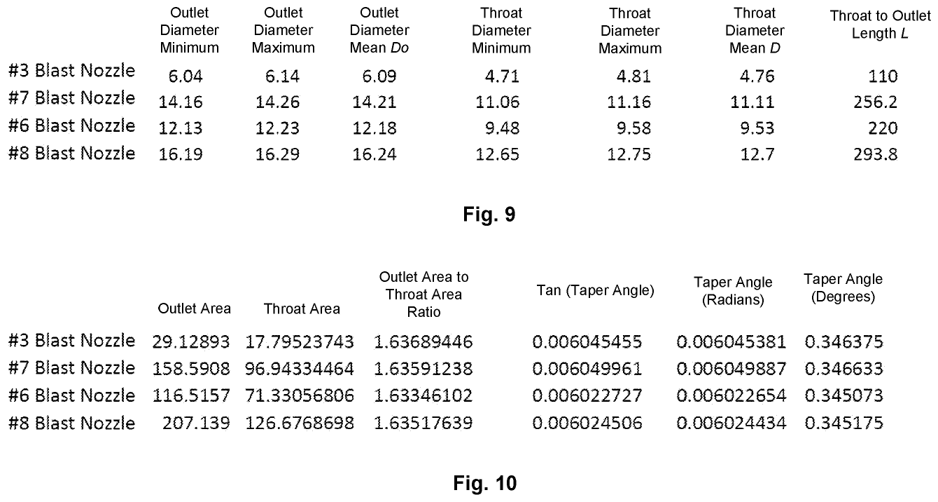

The 220 mm #6 nozzle 100 that is illustrated in FIGS. 5 to 8 had the best performance of those tested. FIG. 8 depicts a longitudinal cross section through the nozzle showing the conduit therethrough with the dimension L being a distance from throat 116 to nozzle outlet 120 of 200 mm.

The blast nozzle 100 is formed with a conduit 102 therethough for accelerating air with abrasive particles at a predetermined pressure. In the present case nozzle 100 is designed for an inlet air pressure of 80 to 120 psi and nominally 100 psi to discharge to sea level ambient atmospheric pressure at 27 degrees C. The pressurised air contains abrasive particles such as #80 Garnet to abrade a workpiece. The conduit 102 includes an inlet portion 104 that converges from an inlet opening 106, for receiving the compressed air, to a throat 116 for accelerating the air to a sonic speed. The inlet portion 104 generally follows a concave-convex curve with an initial concave portion 110 that proceeds through: an inflection point 112 to a convex portion 114. The convex portion 114 ends in a throat 116, of zero axial length along the conduit, from which an outlet portion 118 extends. The outlet portion 118 diverges from the throat 116 to a nozzle outlet 120 for accelerating the air from the throat 116 to a super-sonic speed. A ratio of the area of the nozzle outlet 120 to area of the throat 116 is selected for expansion of the air through the nozzle 100 so it is neither under-expanded nor overexpanded as it exits the outlet 120 but rather is “ideally” expanded. The area ratio is about 1.6 for compressed air applied in the range of 80 psi to 120 psi and optimally 100 psi. Accordingly, the pressurised air exits the nozzle outlet 120 in a jet at ambient pressure. The jet imparts drag on the abrasive particles between the nozzle outlet and the workpiece. Consequently, the energy of the particles is increased over the standoff distance between the nozzle outlet 118 and the surface of the workpiece. The standoff distance is typically around 350 mm to 600 mm from the nozzle outlet to the workpiece in use. Consequently, nozzles according to embodiments herein are more effectively able to clean/abrade the surface of the workpiece than a nozzle designed to work in an overexpanded or under-expanded mode.

The inlet opening 106 has a diameter of 32 mm, the throat 116 has a diameter of 9.53 mm and zero length, and the nozzle outlet 120 has a diameter of 12.18 mm.

The throat and the nozzle outlet are separated by a distance L of 220 mm. The throat and the nozzle inlet are separated by a distance of about 36 mm. It will be realised that these dimensions are provided for exemplary purposes only and are non-limiting of nozzles according to embodiments of the invention.

In determining the optimal nozzle length, it was found that 220 mm was the best of the nozzles that were tested for #60/30 garnet (0.3 mm particle size, 4100 lg/m\hat{ }3 density). The optimal length may be longer in other embodiments such as 300 mm. There may be other considerations, such as access and ergonomics, which limit the utility of a longer nozzle. In general, longer nozzles are better suited to larger, heavier abrasive blends, whilst shorter nozzles are better suited for lighter and smaller blends. A preferred range on the diverging section length L for embodiments of the nozzle is 70-300 mm.

### Nozzle Shape Variation

The converging inlet may vary though it is preferred that it is generally concave-convex. However, the inlet shape is not believed to be the main factor in achieving high performance and thus other shapes, though less preferable, may be used, for example a frustoconical inlet shape.
The nozzle outlet area may vary such that the design pressure is between 80 and 120 psi without adversely impacting design/off-design performance.
The outlet diverging section may be contoured such that it takes the form of a bell shape, or a cone (i.e. a frusta-conical shape) or a combination of a bell followed by a cone. Other shapes may also be suitable for minimising entropy rise too.

Although discussion herein has primarily focused on using a #6 size nozzle, as it is most commercially significant in the global market, embodiments of the nozzle can be scaled to range over at least #3 to #12 nozzles.

For example, dimensions and outlet area to throat area ratios of embodiments of #3, #7, #6 and #8 blast nozzles are set out in the tables of FIGS. 27 and 28 where L is the diverging section length, i.e. the length of the outlet portion as indicated in FIG. 8, is the throat diameter and D is the outlet diameter.

Nozzles according to other embodiments include modifications such as varying the inlet by adjusting the shape of the concave-convex wall of the inlet portion for example. To modify the diverging section, the ratio of the area of the outlet to the area the throat should be fixed. The length can be scaled such that L/D remains constant.

It will be realised that blast nozzles according to embodiments of the present invention may be used with other particles that are used for blasting too, for example glass, walnut, plastic, steel ball, etc, in place of garnet.

In use pressurised air containing abrasive particles, for example in a hose from a blast pot, is applied to the inlet opening of the nozzle at a sub-sonic velocity. The converging diverging shape of the nozzle conduit (or as the nozzle conduit may be simply referred to herein “the nozzle”) that has been discussed operates upon the air to produce a supersonic jet at the outlet of the nozzle. An operator directs the jet from the outlet of the nozzle at the surface wherein the particles travel a distance from the outlet to the surface whilst being accelerated in the jet.

A preferred method for designing a nozzle according to an embodiment of the present invention is:

### Inputs for the Design Process are:

Abrasive type
Nominal operating pressure ratio
throat diameter
Hose connection diameter

Nozzles discussed herein have been designed for operation with air at 100 psi gauge inlet pressure, discharging to sea level pressure (7.8 pressure ratio), operating with garnet abrasive (density of 4100 kg/m\hat{ }3, particle size 180-300 micron diameter). Development work has been completed with the #6 nozzle, which has a 6/16″ diameter throat.

1) Set geometry outline—a converging diverging geometry composed of a:
i) knife edge (i.e. zero axial length) throat
ii) Concave-convex inlet section—sized to match mating hose inlet (e.g. typically a diameter of 32 mm is used on such blast hoses) and nozzle throat
iii) Conical outlet section—area ratio sized according to expansion ratio characteristics, length according to abrasive used

2) Inlet geometry definition

Subject to general form in 1) ii), Use CFD (computational fluid dynamics) to shape optimise for minimum entropy rise over section

3) Outlet section area ratio (i.e. ratio of outlet area to throat area)

Preliminary estimate determined from isentropic flow equations for given operating pressure ratio.

Area ratio adjusted to account for boundary layer growth. There is no simple formula or ratio for this. This can be done by either:
i) Determining boundary layer displacement thickness (a function of flow regime and geometry), and adding this to the outlet (not preferred)
ii) Using CFD shape optimisation with entropy minimisation as an objective function—which is separate to the inlet design.

4) Outlet length

Preferably L/D is about 25 for garnet, where L is the diverging section length (throat to exit), and D is the throat diameter. However, experiments indicate that performance is still viable from L/D 15-30 approx. Heavier abrasives, i.e. larger particles or denser media, will preferably use longer nozzles and the converse is also true.

From the preceding description it will be appreciated that a blast nozzle is provided that has a conduit through it for accelerating air applied to the blast nozzle at pressure greater than ambient pressure. The air contains abrasive particles for abrading or “blasting” a workpiece. For example, the workplace may be a metal assembly that has surface contamination or corrosion that is to be removed. The conduit includes an inlet portion that converges from an inlet opening for receiving the air, to a throat for accelerating the air to a sonic speed. The conduit also includes an outlet portion that extends from the throat to a nozzle outlet for accelerating the air from the throat to a super-sonic speed at the nozzle outlet. A ratio of area of the nozzle outlet to area of the throat is selected for expansion of the air through the conduit so that air is emitted from the nozzle outlet in a jet at an ambient pressure. The jet imparts drag on the abrasive particles between the nozzle outlet and the workpiece which has been found to improve abrading of the workpiece by the abrasive particles.

A blasting system is provided that comprises a blast pot in combination with the blast nozzle. A pressurised air outlet of the blast pot is coupled to the inlet of the blast nozzle and the blast pot is configured to produce air pressurised at 80 psi to 120 psi with the abrasive particles entrained in the air.

It will also be understood from the previous disclosure that a method of making a blast nozzle has been described. The blast nozzle has a conduit through it for accelerating air. The conduit has an inlet portion that converges from an inlet opening for receiving pressurised air to a throat and an outlet portion that diverges from the throat to a nozzle outlet. The method involves forming a parametric curve for defining a surface of the outlet portion and estimating entropy rise of a fluid flow through the outlet portion for a number of different shapes of the parametric curve. The method includes finalising the parametric curve by determining one of a number of different shapes ascertained to minimise entropy rise of the fluid flow along the outlet portion. The blast nozzle is then produced with the outlet portion having a curve based upon the finalised parametric curve.

In compliance with the statute; the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A blast nozzle having a conduit therethrough for accelerating air applied to the blast nozzle at pressure greater than ambient pressure, the air containing abrasive particles for abrading a workpiece, the conduit including:
an inlet portion converging from an inlet opening for receiving the air, to a throat for accelerating the air to a sonic speed;
an outlet portion extending from the throat to a nozzle outlet for accelerating the air from the throat to a super-sonic speed at the nozzle outlet; and
wherein a ratio of area of the nozzle outlet to area of the throat is selected for expansion of the air through the conduit so that air is emitted from the nozzle outlet in a jet at an ambient pressure wherein the jet imparts drag on the abrasive particles between the nozzle outlet and the workpiece for improving abrading of the workpiece by the abrasive particles.

2. The blast nozzle of claim 1, wherein the inlet portion converges from the inlet opening for receiving the air at 80-120 psi to the throat for accelerating the air to the sonic speed at the throat.

3. The blast nozzle of claim 1, wherein the ratio of area of the nozzle outlet to the area of the throat is 1.66+/−0.05 to emit the air, received into the inlet opening at 80-120 psi, from the nozzle outlet in the jet wherein the jet imparts drag on the abrasive particles between the nozzle outlet and the workpiece for abrading of the workpiece by the abrasive particles.

4. The blast nozzle of claim 3, wherein the ratio of the area of the nozzle outlet to the area of the throat is 1.64.

5. The blast nozzle of claim 3, wherein in use a ratio of pressure of the air at the throat to pressure of air at the nozzle outlet is between 6 and 9.5 for emitting the air from the nozzle outlet in the jet wherein the jet imparts drag on the abrasive particles between the nozzle outlet and the workpiece for abrading of the workpiece by the abrasive particles.

6. The blast nozzle of claim 5, wherein the ratio of pressure of the air at the throat to pressure of air at the nozzle outlet is between 6.5 and 9.0.

7. (canceled)

8. The blast nozzle of claim 6, wherein the ratio of pressure of the air at the throat to pressure of air at the nozzle outlet is 7.8.

9. (canceled)

10. The blast nozzle of claim 1, wherein the throat has a length that is zero or less than 5% of a length of the outlet portion.

11. The blast nozzle of claim 1, wherein the outlet portion includes a first diverging sub-portion following the throat.

12. The blast nozzle of claim 11, wherein the outlet portion includes a second diverging sub-portion following the first diverging sub-portion.

13. The blast nozzle of claim 12, wherein the first diverging sub-portion diverges more than the second diverging sub-portion per unit of axial length along the conduit.

14. The blast nozzle of claim 12, wherein the first diverging sub-portion comprises a bell shape.

15-24. (canceled)

25. A method of making a blast nozzle having a conduit therethrough for accelerating air, the conduit having an inlet portion converging from an inlet opening for receiving pressurised air to a throat and an outlet portion diverging from the throat to a nozzle outlet, the method comprising:
forming a parametric curve for defining a surface of the outlet portion;
estimating entropy rise of a fluid flow through the outlet portion for a number of different shapes of the parametric curve;
finalising the parametric curve as a finalised parametric curved determined as a one of the number of different shapes ascertained to minimise the entropy rise of the fluid flow along the outlet portion; and
producing the blast nozzle with the outlet portion having a curve based upon the finalised parametric curve.

26. The method of making the blast nozzle of claim 25, wherein the estimating the entropy rise of the fluid flow is performed for fluid comprising pressurised air applied to the inlet opening in a pressure range of 80 psi to 120 psi.

27. The method of making the blast nozzle of claim 26, wherein the estimating the entropy rise of the fluid flow is performed for fluid comprising pressurised air applied to the inlet opening at 100 psi.

28. The method of making the blast nozzle of claim 25, wherein the parametric curve is defined by a plurality of control points.

29. The method of making the blast nozzle of claim 28, wherein the different shapes of the parametric curve are attained by varying a number of the plurality of control points.

30. The method of making the blast nozzle of claim 29, wherein the plurality of control points includes a fixed control point at the throat.

31. The method of making the blast nozzle of claim 25, wherein producing the blast nozzle includes forming the outlet portion corresponding to the finalised parametric curve.

32. The method of making the blast nozzle of claim 25, wherein producing the blast nozzle includes forming the outlet portion as an approximation of the finalised parametric curve wherein an area of the nozzle outlet corresponds to a nozzle outlet area according to the finalised parametric curve and an area of the throat corresponds to a throat area according to the finalised parametric curve.

33. The method of making the blast nozzle of claim 32, wherein the approximation of the finalised parametric curve comprises a straight line from the throat to the nozzle outlet.

34. The method of making the blast nozzle of claim 25, wherein a ratio of area of the nozzle outlet to area of the throat results in pressurised air entering the inlet being emitted from the nozzle outlet in a jet at ambient pressure wherein the jet imparts drag on abrasive particles entrained in the air, between the nozzle outlet and a workpiece to thereby improve abrading of the workpiece by the abrasive particles.

35-38. (canceled)
